(19) United States
(12) Patent Application Publication
(10) Pub. No.: US 2017/0236345 A1
(43) Pub. Date: Aug. 17, 2017

(54) RFID LOCK

(71) Applicant: BRENDAN WATTERS, SILVER SPRING, MD (US)

(72) Inventor: BRENDAN WATTERS, SILVER SPRING, MD (US)

(73) Assignee: TELECOMMUNICATION SYSTEMS, INC, ANNAPOLIS, MD (US)

(21) Appl. No.: 15/042,038

(22) Filed: Feb. 11, 2016

(51) Int. Cl. G07C 9/00

(52) U.S. Cl. CPC G07C 9/00111; G07C 9/00309; G07C 2009/00769

(57) ABSTRACT

An access server can be configured to receive an open lock request from a radio frequency identification (RFID) lock that is provided in response to a holder of an RFID badge positioning the RFID badge near the RFID lock. The open lock request can include a unique identifier (ID) assigned to the RFID badge. The access server can also be configured to retrieve a user record based on the unique ID of the RFID badge to determine a secondary device ID. The access server can further be configured to determine whether the secondary device ID is present in a wireless device list that characterizes a list of wireless devices communicating with a wireless network physically encompassing the RFID lock.

### TECHNICAL FIELD

This disclosure relates to an RFID lock. More particularly, this disclosure relates to a RFID lock that communicates with an access server.

### BACKGROUND

Radio Frequency identification (RFID) is the wireless use of electromagnetic fields to transfer data, for the purposes of automatically identifying and tracking tags attached to objects. The tags embed electronically stored information. Some tags are powered by electromagnetic induction from magnetic fields produced near the reader. Some types collect energy from the interrogating radio waves and act as a passive transponder. Other types have a local power source such as a battery and may operate at hundreds of meters from the reader. Unlike a barcode, the tag does not necessarily need to be within line of sight of the reader and may be embedded in a tracked object.

### SUMMARY

One example relates to an access server that can include one or more computing devices. The access server can be configured to receive an open lock request from a radio frequency identification (RFID) lock that is provided in response to a holder of an RFID badge positioning the RFID badge near the RFID lock. The open lock request can include a unique identifier (ID) assigned to the RFID badge. The access server can also be configured to retrieve a user record based on the unique ID of the RFID badge to determine a secondary device ID. The access server can further be configured to determine whether the secondary device ID is present in a wireless device list that characterizes a list of wireless devices communicating with a wireless network physically encompassing the RFID lock.

Another example relates to a system that can include an RFID lock that includes an RFID sensor. The RFID lock can be configured to provide an open lock command in response to detecting an RFID badge being positioned in close proximity to the RFID sensor. The system can also include an access server comprising one or more computing devices. The access server can be configured to receive the open lock request, wherein the open lock request includes an ID embedded in the RFID badge. The access server can also be configured to determine whether a secondary device that is assigned to the same user as the RFID badge is in communication with a wireless network physically encompassing the RFID lock. The access server can further be configured to control access to content guarded by the RFID lock based on the determining.

Still another example relates to a method that can include receiving an open lock request from an RFID lock, wherein the open lock request include a unique ID for a badge held near the RFID lock and an ID assigned to the RFID lock. The method can also include retrieving a user record associated with the RFID badge and a lock record associated with the RFID lock. The method can further include determining whether a user assigned to the RFID badge has authority to access content guarded by the RFID lock based on an authorization level defined in the user record and a security level defined in the lock record. The method can yet further include matching a secondary device ID included in the user record with a device ID on a wireless device list, wherein the wireless device list characterizes a list of wireless devices communicating with a specific wireless network.

### BRIEF DESCRIPTION OF THE DRAWINGS

FIG. 1 illustrates an example of a system for controlling access to content guarded by a Radio Frequency Identification (RFID) lock.

FIG. 2 illustrates a user record assigned to a user of an RFID badge.

FIG. 3 illustrates an example of a lock record associated with an RFID lock.

FIG. 4 illustrates an example of an access server for controlling access to content guarded by an RFID lock.

FIG. 5 illustrates a flowchart of an example method for controlling access to content guarded by an RFID lock.

### DETAILED DESCRIPTION

This disclosure relates to the control of access to content guarded by a Radio Frequency Identification (RFID) lock. In some examples, an access server can be configured to receive an open lock request from the RFID lock that is provided in response to a holder of an RFID badge positioning (holding) the RFID badge near the RFID lock. The open lock request can include a unique identifier (ID) assigned to the RFID badge. The access server can retrieve a user record based on the unique ID of the RFID badge to determine a secondary device ID (e.g., a smart phone or other wireless end-user device). The access server can determine whether the secondary device ID is present in a wireless device list that characterizes a list of wireless devices communicating with a wireless network physically encompassing the RFID lock. If the access server determines that the secondary device ID is present in the list of wireless devices, the access server can send an open lock command to the RFID lock, thereby allowing access to the content guarded by the RFID lock to the holder of the RFID badge. The systems and methods disclosed herein institute a security check that (at a minimum) verifies that the holder of the RFID badge also possesses the secondary device that is assigned to the user that is assigned to the RFID badge.

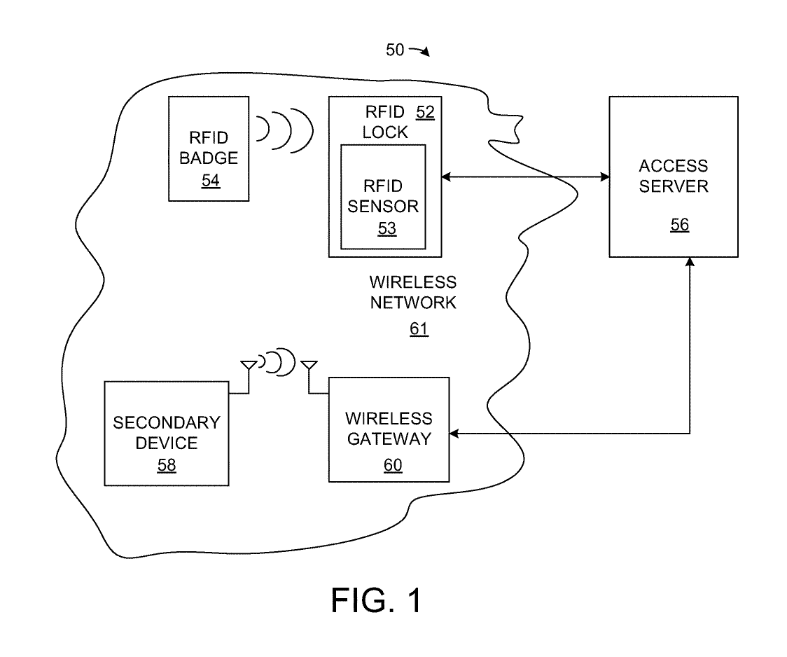

FIG. 1 illustrates an example of a security system 50 for controlling access to content guarded by an RFID lock 52. The security system 50 can be configured to implement a primary and secondary authentication in order to open the RFID lock 52. The RFID lock 52 can be guarding access to a building (e.g., door lock), a vault, a computer terminal or other security based system.

The RFID lock 52 can include an RFID sensor 53 that can emit a low frequency (LF) electromagnetic signal that can be detected by an RFID badge 54. Typically, a user holds the RFID badge 54 near (e.g., within about 4 centimeters) the RFID lock 52 (and the RFID sensor 53) and the RFID badge 54 wirelessly transmits a unique identifier (ID) for the RFID badge 54, which unique ID can be referred to as a badge ID. The badge ID could be, for example, an alphanumeric string. The RFID lock 52 can communicate with an access server 56 via a network, such as a private network (e.g., a local area network), a public network (e.g., the Internet) or a combination thereof (e.g., a virtual private network).

Additionally, the user of the RFID badge 54 can also be assigned a secondary device 58. The secondary device 58 can be a wireless end-user device, such as a mobile phone, a feature phone, a tablet computer, a personal digital assistant (PDA) etc. The secondary device 58 can establish a communication channel with a wireless gateway 60. The wireless gateway 60 can be, for example, a WiFi hotspot (e.g., a WiFi router), a Bluetooth device, a cellular communication carrier network node (e.g., a cell tower, a home location register, etc.) or nearly any other wireless network communication gateway. The wireless gateway 60 can be a node on a wireless network 61 that encompasses the RFID lock 52. For instance, the wireless gateway 60 could be a WiFi hotspot for the wireless network 61, and the physical footprint of the wireless network 61 that encompasses the RFID lock 52. In such a situation, the wireless network 61 could be a campus wide WiFi network and the RFID lock 52 can guard access to a door on the campus. Additionally, it is noted that the RFID lock 52 may or may not be a node on the wireless network 61.

The secondary device 58 can provide a unique ID for the secondary device 58 to the wireless gateway 60, which unique ID can be referred to as a secondary device ID. The secondary device ID could be, for example, a Media Access Control (MAC) address, a Bluetooth ID, a Mobile Subscriber ID (MSID), etc. The wireless gateway 60 can forward the secondary device ID to the access server 56. In some examples, the access server 56 can maintain a list of all wireless devices (through associated secondary device IDs) communicating with the wireless gateway 60. In other examples, the list of wireless devices can be stored on an external system.

The RFID lock 52 can provide an open lock request to the access server 56. The open lock request can include the badge ID of the RFID badge 54 as well as an ID for the RFID lock 52 itself. The ID of the lock can be referred to as a lock ID. In response, the access server 56 can be configured to access a lookup table or database for a user record associated with the unique ID of the RFID badge 54. The user record associated with the RFID badge 54 can include information associated with a user of the RFID badge 54 (e.g., an authorized holder or wearer of the RFID badge 54).

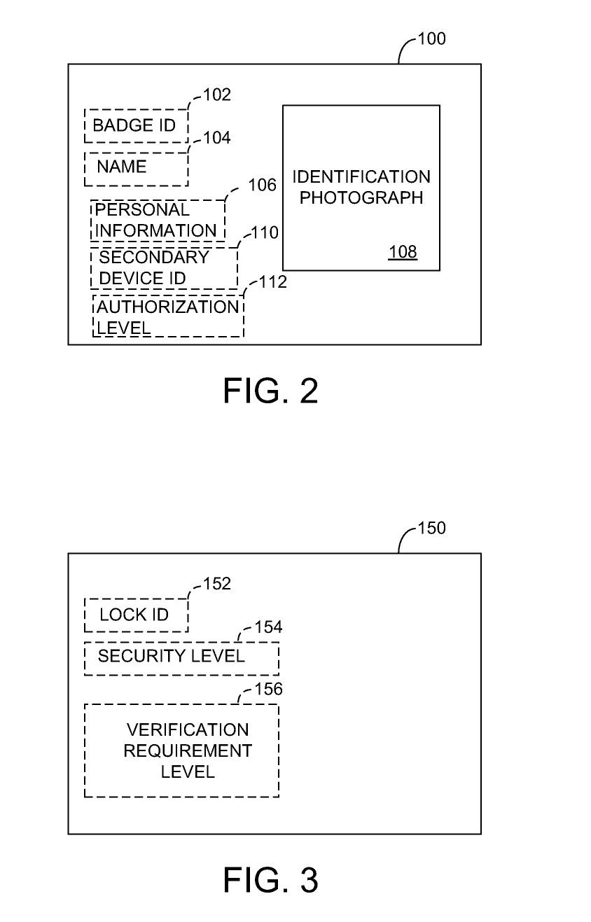

FIG. 2 illustrates an example of a user record 100 that could be retrieved by the access server 56. The user record 100 can include fields that can be employed to identify the user of the RFID badge 54. The user record 100 can include a badge ID 102 for the RFID badge 54. The user record 100 can also include a name 104 of the user and personal information 106 for the user that is assigned the RFID badge 54. The personal information 106 can include, for example, contact information (e.g., an address) and security information (e.g., pet names, place of birth, name of spouse, passwords, etc.). In some examples, other information such as an identification photograph 108 (e.g., a facial picture) of the user that is assigned to the RFID badge 54. Additionally, the user record 100 can include a secondary device ID 110 that can be an identifier for a secondary device that is assigned to the user of the RFID badge 54. The secondary device ID can be, for example, a media access control (MAC) ID, a Bluetooth ID, etc. The user record 100 can further include an authorization level 112 that can indicate permissions granted to the user associated with the user record 100.

Additionally, the access server 56 can be configured to access another lookup table or database to retrieve a lock record associated with the lock ID. FIG. 3 illustrates an example of a lock record 150 that could be retrieved by the access server 56. The lock record 150 can include a lock ID 152 that can uniquely identify the RFID lock 52. In some examples, the lock ID 152 can be an alphanumeric string. In other examples, the lock ID 152 can be a MAC address, an Internet Protocol (IP) address, etc. The lock record 150 can also include a security level 154 associated with the RFID lock 52. The security level 154 can include data that characterizes an authorization level needed to access the content guarded by the RFID lock 52. Additionally, the lock record 150 can include a verification requirement level 156 that can identify a level and type of identification verification needed to grant access to the content guarded by the RFID lock 52.

Referring back to FIG. 1, the access server 56 can examine the authorization level associated with the RFID badge 54 (from the database record). If the authorization level indicates that the user associated with the RFID badge 54 is equal to or greater than the security level defined in the lock record of the RFID lock 52, the access server 56 can continue with verification of the holder of the RFID badge 54. Otherwise, the access server 56 can cease further verification and/or notify another entity (e.g., a security desk) that an unauthorized person is attempting to access the contents guarded by the RFID lock 52.

Presuming that the user record indicates that the user assigned to the RFID badge 54 does have permission to access the contents guarded by the RFID lock 52, the access server 56 can identify the secondary device ID included in the user record associated with the RFID badge 54. The access server 56 can review the list of devices to match the secondary device ID (associated with the RFID badge 54) with a device communicating with the wireless gateway 60. In response to identifying the match, the access server 56 can send an open command (e.g., an authorization signal) to the RFID lock 52, and the RFID lock 52 can open, thereby granting access to contents protected by the RFID lock 52 to the holder of the RFID badge 54. In this manner, the holder (user) of the RFID badge 54 can gain access to the contents of the RFID lock 52 seamlessly. In fact, in many instances, the secondary device 58 may be configured to automatically communicate (e.g., via a WiFi or Bluetooth search) with the wireless gateway 60, such that (in some examples) no additional physical actions are needed by the holder (user) of the RFID badge 54 to open the RFID lock 52. Additionally, in many such situations, no additional software would be needed on the secondary device 58.

Additionally, in some examples, the verification requirement level in the lock record of the RFID lock 52 can include data indicating that prior to causing the RFID lock 52 to open, the access server 56 needs to ensure that the holder of the RFID badge 54 passes a security challenge to the user of the RFID badge 54 and the user of the secondary device 58. The security challenge could be, for example, a request for a password, a security question, etc. that can be provided to an application (e.g., an app) executing on the secondary device 58. Additionally or alternatively, in some examples, the access server 56 can cause the RFID lock 52 to output (via a display) a passcode, and the security challenge can include entry of the passcode into the secondary device 58. Further, in some examples, the access server 56 can send the secondary device 58 the passcode, and require that the passcode be entered into a keypad on (or near) the RFID lock 52. In this manner, the security challenge can ensure (or at least further increase the chances) that the holder of the RFID badge 54 also physically possesses the secondary device 58 and that the user of the RFID badge 54 is authorized to gain access to the contents protected by the RFID lock 52.

By employment of the security system 50, security holes arising from conventional RFID badges security systems can be reduced and/or eliminated. For instance, in a conventional RFID badge security system in a building, possession of an authorized RFID badge acts as a “key” that grants the holder access to the building without further inquiry. Thus, in a conventional system an unauthorized user needs simply to unlawfully acquire (steal) an RFID badge and hold the stolen RFID badge near a sensor, and access to the building would be granted. In fact, often RFID badges of such conventional RFID systems identify a company or enterprise that issues the badges, thereby guiding such an unauthorized user to a place where the stolen RFID badge could be employed.

In contrast, in the security system 50, the holder (user) of the RFID badge 54 would need to possess the RFID badge 54 and the secondary device 58. Additionally, in some examples, the additional security challenge can be issued, thereby further increasing the chances that the holder of the RFID badge 54 was authorized to access the content protected the by the RFID lock 52.

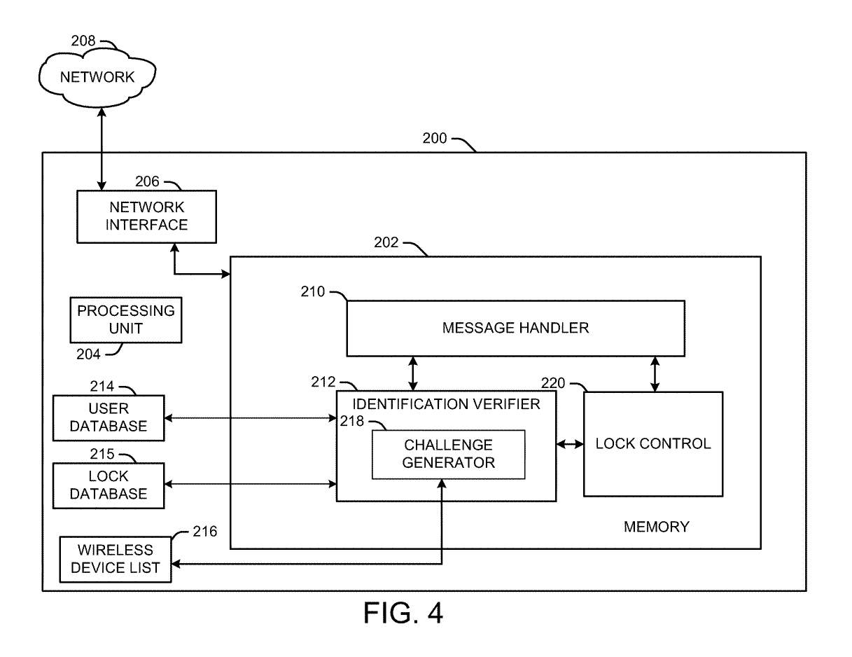

FIG. 4 illustrates an example of an access server 200 for controlling access to content guarded by an RFID lock. The access server 200 can be employed, for example, to implement the access server 56 illustrated in FIG. 1. The access server 200 can include a memory 202 that can store machine readable instructions. The memory 202 could be implemented, for example, as non-transitory computer readable media, such as volatile memory (e.g., random access memory), nonvolatile memory (e.g., a hard disk drive, a solid state drive, flash memory, etc.) or a combination thereof. The access server 200 can also include a processing unit 204 to access the memory 202 and execute the machine-readable instructions. The processing unit 204 can include, for example, one or more processor cores. The access server 200 can include a network interface 206 configured to communicate with a network 208. The network interface 206 could be implemented, for example, as a network interface card. The network 208 could be implemented, for example, as a private network (e.g., local area network or a carrier network) as a public network (e.g., the Internet), or a combination thereof (e.g., a virtual private network).

The access server 200 could be implemented, for example in a computing cloud. In such a situation, features of the access server 200, such as the processing unit 204, the network interface 206, and the memory 202 could be representative of a single instance of hardware or multiple instances of hardware with applications executing across the multiple of instances (i.e., distributed) of hardware (e.g., computers, routers, memory, processors, or a combination thereof). Alternatively, the access server 200 could be implemented on a single dedicated server.

The memory 202 can include a message handler 210 that can receive incoming messages from the network 208 (via the network interface 206) and transmit messages to other nodes on the network 208. The message handler 210 can receive an open lock request from an RFID lock, such as the RFID lock 52 of FIG. 1. The open lock request can be provided, for example, in response to a holder of an RFID badge positioning the RFID badge in close proximity to the RFID lock 52. The open lock request can include, for example, a unique ID for the RFID badge and a lock ID for the RFID lock. The message handler 210 can forward the RFID request to an identification verifier 212 of the memory 202.

In response to the open lock request, the identification verifier 212 can access a user database 214 and retrieve a user record based on the unique ID of the RFID badge. In some examples, the user database 214 can be stored locally with the access server 200. In other examples, the user database 214 could be stored externally (e.g., on a dedicated database server) and accessed through the network 208. Additionally, it is noted that in some examples, the user database 214 can be implemented as a relational database or another data structure, such as a look-up table.

In some examples, the user record can be implemented, for example, in a manner similar to the user record 100 illustrated in FIG. 2. In such a situation, the identification verifier 212 can determine whether the user assigned to the RFID badge is authorized to access content guarded by the RFID lock based on an authorization level included in the user record associated with the RFID badge.

Additionally, in response to the open lock request, the identification verifier 212 can access a lock database 215 and retrieve a lock record based on the lock ID included in the open lock request. The lock database 215 can be stored external to the access server 200 or on an internal device. Additionally, in some examples, the lock database 215 can be implemented as a relational database or other data structure, such as a look-up table. Moreover, in some examples, the user database 214 and the lock database 215 can be integrated.

The identification verifier 212 can examine the authorization level of the user record with the security level defined in the lock record to determine if the user associated with the RFID badge is authorized to access the content guarded by the RFID lock. Additionally, the identification verifier 212 can identify a secondary device ID in the user record. In some examples, the secondary device ID could be, for example, a MAC address or Bluetooth address associated with a secondary device that is assigned to the same user as the RFID badge. In other examples, the secondary device ID could be the MSID or Mobile Identification Number (MIN) assigned to the secondary device. The secondary device could be, for example, a smart phone, a feature phone, a tablet computer or other wireless portable device.

In some examples, the identification verifier 212 can query a wireless device list 216 to determine if a device ID in the wireless device list 216 matches the secondary device ID included in the user record associated with the RFID badge. The wireless device list 216 could be representative of a look-up table stored on an external system such as a wireless gateway (e.g., the wireless gateway 60 illustrated in FIG. 1). In other examples, the wireless device list 216 could be stored locally on the access server 200, and updates to the wireless device list 216 could be received asynchronously (e.g., as a push) from the wireless gateway or provided from the wireless gateway in response to an update request provided by the access server 200.

In some examples, the wireless gateway could be a WiFi router, a Bluetooth device, etc. In other examples, the wireless gateway could be an HLR associated with a carrier network.

In response to identifying a match of a wireless ID in the wireless device list 216 with the secondary device ID included in the user record, the identification verifier 212 can examine a verification requirement level of the lock record (e.g. the verification requirement level 156 of FIG. 3) to determine if a security challenge is needed to access content guarded by the RFID lock. If further verification is needed, the identification verifier 212 can include a challenge generator 218 that can issue a security challenge for the secondary device. In some examples, the challenge generator 218 can provide the message handler 210 with a messaged addressed to the secondary device ID included in the user record. In such a situation, the challenge generator 218 can operate as a servlet application that communicates with a client application executing on the secondary device (e.g., an “app”).

The security challenge could be, for example, a request for additional information included in the user record (e.g., personal information of the user record), such as personal information, a security question (e.g., a password, the name of a pet, a middle name of a parent of the user associated with the RFID badge, etc.). In response to the request for additional information, the user of the secondary device can enter (via the secondary device) the requested additional information that can be received at the challenge generator 218. If the requested information received from the secondary device matches the information included in the user record, the challenge generator 218 can determine that the security challenge has been satisfied (passed).

Additionally or alternatively, the challenge generator 218 can send a passcode (e.g., numeric code or an alphanumeric code) to the secondary device. Additionally, in this situation, the secondary device can display the passcode for the user of the secondary device and the user of the secondary device can input the passcode into a keypad (or other input device) that is physically near the RFID lock. In this situation, the message hander 210 can receive a security challenge response that includes the passcode inputted into the RFID lock. Presuming that the passcode inputted into the RFID lock matches the passcode sent to the secondary device, the challenge generator 218 can confirm that the security challenge has been satisfied (passed).

In this manner, the security challenges can verify that the holder of the RFID badge also physically possesses the secondary device and/or verify that the holder of the RFID badge is the same person to which the RFID badge is assigned.

Upon the identification verifier 212 determining that no further verification of the holder of the RFID badge is needed, the identification verifier 212 can send an identification confirmation to a lock control 220. The identification confirmation can include a lock identifier (included in the original open request from the RFID lock). In response, the lock control 220 can generate a lock open message for the RFID lock that commands the RFID lock to open. The lock control 220 can forward the lock open message to the message handler 210, which can send the lock open message to the RFID lock via the network 208.

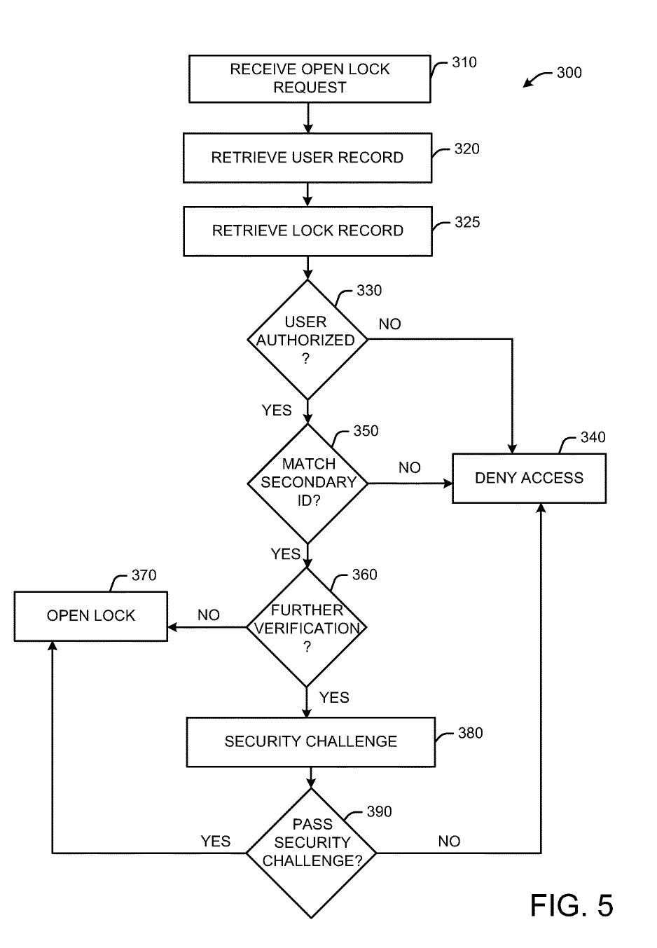

In view of the foregoing structural and functional features described above, example methods will be better appreciated with reference to FIG. 5. While, for purposes of simplicity of explanation, the example method of FIG. 5 is shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method. The example method of FIG. 5 can be implemented as instructions stored in a non-transitory machine-readable medium. The instructions can be accessed by a processing resource (e.g., one or more processor cores) and executed to perform the methods disclosed herein.

FIG. 5 illustrates a flowchart of an example method 300 for controlling access to content guarded by an RFID lock, such as the RFID lock 52 illustrated in FIG. 1. The method 300 can be implemented, for example, by the access server 56 illustrated in FIG. 1 and/or the access server 200 illustrated in FIG. 4. At 310, the access server can receive an open lock request from the RFID lock via a network (e.g., the network 208 illustrated in FIG. 4). The open lock request can be provided in response to a holder of an RFID badge positioning the RFID badge near the RFID lock (e.g., at an RFID sensor). The open lock request can include a badge ID for the RFID badge and a lock ID for the RFID lock.

At 320, the access server can retrieve a user record based on the badge ID for the RFID badge (e.g., the user record 100 illustrated in FIG. 2) from a user database (e.g., the user database 214 illustrated in FIG. 4). At 325, the access server can retrieve a lock record associated with the RFID lock from a lock database (e.g., the lock database 215 illustrated in FIG. 4).

At 330 the access server can make a determination as to whether a user identified in the user record associated with the RFID badge is authorized to access the content being guarded by the RFID lock. The determination can be made, for example, based on a comparison of the authorization level defined in the user record with the security level defined in the lock record. If the determination at 330 is negative (e.g., NO), the method 300 can proceed to 340. If the determination at 330 is positive (e.g., YES) the method 300 can proceed to 350.

At 340, the access server can deny the open lock request, such that the RFID lock remains locked. In some examples, the denial of the open lock request can also cause the access server to notify another entity (e.g., a security desk) that an unauthorized person is attempting to access the content being guarded by the RFID lock.

At 350, the access server can make a determination as to whether a secondary ID included in the user record matches a device ID included in a wireless device list (e.g., the wireless device list 216 illustrated in FIG. 4). If the determination at 350 is negative (e.g., NO), the method 300 can proceed to 340. If the determination at 350 is positive (e.g., YES), the method 300 can proceed to 360.

At 360, the access server can make a determination as to whether further verification of the holder of the RFID badge is needed. The determination at 360 can be based, for example, on data included in a verification requirement level (e.g., the verification requirement level 156 of FIG. 3) in the lock record associated with the RFID lock. If the determination at 360 is negative (e.g., NO), the method 300 can proceed to 370. If the determination at 360 is positive (e.g., YES), the method 300 can proceed to 380.

At 370, the access server can send an open lock command to the RFID lock. The open lock command can cause the RFID lock to open and grant access to the contents being guarded to the holder of the RFID badge.

At 380, the access server can issue a security challenge to the holder of the RFID badge, in a manner described herein. The type of the security challenge can, in some examples, be dictated by the verification requirement level in the lock record associated with the RFID lock. At 380, the access server can determine whether the security challenge has been passed. If the determination is positive (e.g., YES), the method 300 can proceed to 370. If the determination is negative (e.g., NO), the method 300 can proceed to 340.

In view of the foregoing structural and functional description, those skilled in the art will appreciate that portions of the systems and method disclosed herein may be embodied as a method, data processing system, or computer program product such as a non-transitory computer readable medium. Accordingly, these portions of the approach disclosed herein may take the form of an entirely hardware embodiment, an entirely software embodiment (e.g., in a non-transitory machine readable medium), or an embodiment combining software and hardware. Furthermore, portions of the systems and method disclosed herein may be a computer program product on a computer-usable storage medium having computer readable program code on the medium. Any suitable computer-readable medium may be utilized including, but not limited to, static and dynamic storage devices, hard disks, solid-state storage devices, optical storage devices, and magnetic storage devices.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processors of a general purpose computer, special purpose computer, or other programmable data processing apparatus (or a combination of devices and circuits) to produce a machine, such that the instructions, which execute via the one or more processors, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

What have been described above are examples. It is, of course, not possible to describe every conceivable combination of structures, components, or methods, but one of ordinary skill in the art will recognize that many further combinations and permutations are possible. Accordingly, the invention is intended to embrace all such alterations, modifications, and variations that fall within the scope of this application, including the appended claims. Where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. An access server comprising one or more computing devices, the access server being configured to:
receive an open lock request from a radio frequency identification (RFID) lock that is provided in response to a holder of an RFID badge positioning the RFID badge near the RFID lock, wherein the open lock request includes a unique identifier (ID) assigned to the RFID badge;
retrieve a user record based on the unique ID of the RFID badge to determine a secondary device ID; and
determine whether the secondary device ID is present in a wireless device list that characterizes a list of wireless devices communicating with a wireless network physically encompassing the RFID lock.

2. The access server of claim 1, wherein the access server is further configured to issue an open lock command to the RFID lock in response to determining that the secondary device ID is included in the wireless device list.

3. The access server of claim 2, wherein the secondary device ID is a Media Access Control (MAC) ID and the wireless network comprises a WiFi network.

4. The access server of claim 2, wherein the secondary device ID is a Bluetooth ID and the wireless network comprises a Bluetooth Network.

5. The access server of claim 2, wherein the secondary device ID is a Mobile Station ID (MSID) and the wireless network comprises a carrier network.

6. The access server of claim 1, wherein the access server is further configured to retrieve a lock record associated with the RFID lock based on a lock identifier included in the open lock request.

7. The access server of claim 1, wherein the access server is further configured to compare an authorization level included in the user record with a security level included in the lock record to determine whether a user associated with the user record is authorized to access content guarded by the RFID lock.

8. The access server of claim 1, wherein the secondary device is a smartphone.

9. The access server of claim 8, wherein the access server is further configured to issue a security challenge to a secondary device employing the secondary device ID, wherein the security challenge requests data included in the user record associated with the RFID badge.

10. The access server of claim 8, wherein the access server is further configured to issue a security challenge to a secondary device employing the secondary device ID, wherein the security challenge requests entry of a passcode into the secondary device or a keypad affixed to the RFID lock.

11. A system comprising:
a radio frequency identification (RFID) lock comprising an RFID sensor, the RFID lock being configured to provide an open lock request in response to detecting an RFID badge being positioned in close proximity to the RFID sensor;
an access server comprising one or more computing devices, the access server being configured to:
receive the open lock request, wherein the open lock request includes an identifier (ID) embedded in the RFID badge;
determine whether a secondary device that is assigned to the same user as the RFID badge is in communication with a wireless network physically encompassing the RFID lock; and
control access to content guarded by the RFID lock based on the determining.

12. The system of claim 11, wherein the access server is further configured to retrieve a user record based on a unique ID of the RFID badge, wherein the user record include a secondary ID that is assigned to the secondary device.

13. The system of claim 12, wherein the determining by the access server comprises matching the secondary ID included in the user record with an ID included in an address list for a portion of the wireless network.

14. The system of claim 13, wherein the secondary ID is a Media Access Control ID for a WiFi network or a Bluetooth ID for a Bluetooth network.

15. The system of claim 13, wherein the secondary ID is a mobile subscriber ID (MSID) for a carrier network.

16. The system of claim 12, wherein the access server is further configured to retrieve a lock record based on a unique ID of the RFID lock included in the lock open request, wherein a lock record includes a security level need to access the content guarded by the RFID lock.

17. The system of claim 11, wherein the RFID lock is configured open the RFID lock in response to the open lock command from the access server.

18. A method comprising:
receiving an open lock request from an RFID lock, wherein the open lock request include a unique identifier (ID) for an RFID badge held near the RFID lock and an ID assigned to the RFID lock;
retrieving a user record associated with the RFID badge and a lock record associated with the RFID lock;
determining whether a user assigned to the RFID badge has authority to access content guarded by the RFID lock based on an authorization level defined in the user record and a security level defined in the lock record;
matching a secondary device ID included in the user record with an device ID on a wireless device list, wherein the wireless device list characterizes a list of wireless devices communicating with a specific wireless network.

19. The method of claim 18, further comprising:
providing an open lock command to the RFID lock in response to the matching.

20. The method of claim 18, further comprising:
providing a security challenge to the secondary device in response to the matching.
